(19) United States
(12) Patent Application Publication
(10) Pub. No.: US 2008/0110821 A1
(43) Pub. Date: May 15, 2008

(54) Embedded water conducting disc module

(75) Inventor: Yu-San Kuo, Taichung City (TW)

Correspondence Address: BIRCH STEWART KOLASCH & BIRCH, PO BOX 747, FALLS CHURCH, VA, 22040-0747, US

(73) Assignee: New Century Membrane Co., Ltd.

(21) Appl. No.: 11/594,867

(22) Filed: Nov. 9, 2006

(51) Int. Cl. B01D 29/46

(52) U.S. Cl. 210/489

(57) ABSTRACT

An embedded water conducting disc module with multiple water conducting discs stacked together to clip a plurality of filtering membranes is provided. Each of the water conducting discs includes a disc body, an opening, at least one locking portion, at least one embedded portion and multiple frames. The disc body includes a first surface and a second surface opposite each other. The opening is defined through the disc body along a central axis and holding the conduit. At least one locking portion is defined inside the opening and is a hook. At least one embedded portion is protruded from the second surface of the disc body and is a fastener interlocked with the hook. The frames alternately protruded outward from a periphery of the disc body. Therefore, the embedded water conducting disc module has the effects of simple and convenient fabrication.

### BACKGROUND

1. Field of Invention

The present invention relates to a water conducting disc, and more particularly to a water conducting disc module for clipping filtering membranes.

2. Description of Related Art

A conventional water filtering device is an interlock water conducting disc module. The interlock water conducting disc module holding a conduit includes multiple water conducting discs, multiple rotatable actinoid vanes, multiple sealing rings and multiple filtering membranes.

Each of the interlock water conducting discs has a body, an aperture, three water conducting holes, a locking portion, a joint portion, two annular grooves and multiple locking holes. The aperture is defined completely through the body along a central axis. The water conducting holes are defined completely through the body around the aperture. The locking portion protrudes from a surface of the body and is L-shaped. The joint portion is formed inside each of the water conducting holes. The annular grooves defined respectively on opposite surfaces of the body. The locking holes alternately defined between the water conducting holes.

The rotatable actinoid vane is set between the adjacent water conducting discs. The sealing rings are respectively mounted in the corresponding annular grooves of the adjacent water conducting discs.

Each of the filtering membranes is stacked on a water conducting disc and a rotatable actinoid vane, and another water conducting disc is stacked on the filtering membrane. The locking portion of one of the water conducting discs is disposed in the water conducting hole of another water conducting disc and is rotated with opposite directions to interlock. Therefore, a convex of the locking portion is held in a concave of the joint portion to firmly engage the corresponding locking portion and joint portion of the adjacent water conducting discs. As a result, the filtering membrane is tightly set between adjacent water conducting discs.

When replacing the filtering membranes is needed, a tool is used to force and press the body of the water conducting disc through the locking holes to separate the adjacent water conducting discs. After the adjacent water conducting discs are separated, the adjacent water conducting discs are rotated with opposite directions for disassembly.

The fabrication of the conventional water conducting disc module is complicated such that the tool is needed to disassemble the water conducting discs. The fabrication cost is also increased and the fastened water conducting discs are easily separated because of the interlock method between the convex and the concave. Therefore, the conventional water conducting disc module is not suitable for the water processing device used in the family.

### SUMMARY

It is therefore an objective of the present invention to provide an embedded water conducting module to solve the fabrication and cost problem of conventional interlock water conducting disc module.

It is another objective of the present invention to provide an embedded water conducting module to conquer the drawback that the conventional interlock water conducting disc module that is easily separated because of its engagement structure.

It is another objective of the present invention to provide an embedded water conducting module to solve the problem that the conventional interlock water conducting disc module, which is not suitable for the water processing device used in the family.

An embedded water conducting disc module is provided and it holds a conduit and clips a plurality of filtering membranes. The embedded water conducting disc module includes multiple water conducting discs stacked with each other, and each filtering membrane is clipped between adjacent water conducting discs. Each of the water conducting discs includes a disc body, an opening, at least one locking portion, at least one embedded portion and multiple frames. The disc body includes a first surface and a second surface opposite to each other. The opening is defined through the disc body along a central axis and holds the conduit. The locking portion is defined inside the opening. The embedded portion is protruded from the second surface of the disc body. The frames alternately protruded outward from a periphery of the disc body.

Engaging the interlaced and corresponding locking portion and embedded portion simplifies the fabrication of the embedded water conducting disc module of the present invention. Additionally, this fabrication method also accelerates the replacement of the filtering membranes. Compared with the conventional interlock water conducting disc module, the fabrication cost of the embedded water conducting disc module of the present invention is reduced.

The embedded portion is a hook, and the locking portion is a fastener engaged with the hook. When the embedded portion is engaged with the locking portion, the embedded water conducting disc is firmly fixed and also easy to disassemble.

Compared to the conventional interlock water conducting disc with separated actinoid vane, the frames of the embedded water conducting disc are integrated with the disc body. Therefore, not only is the fabrication procedure diminished but also the cost is reduced with the fewer members.

As the previous description, the embedded water conducting disc module of the present invention has some advantages as following: easier fabrication, convenient disassembly, fewer members, lower fabrication cost and suitable for the family filtering device.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention. In the drawings,

FIG. 1 shows a perspective exploded view of an embodiment of the embedded water conducting disc module of the present invention;

FIG. 2 shows a perspective view of the embodiment of an embedded water conducting disc of the module in FIG. 1;

FIG. 3 shows a sectional view of the module with two discs and one filtering membrane of the embodiment;

FIG. 4 shows an enlarged view in partial in accordance with FIG. 3;

FIG. 5 shows an enlarged view in partial in accordance with FIG. 3; and

FIG. 6 shows a perspective sectional view of a filtering device that uses the embodiment of the embedded water conducting disc module in FIG. 1.

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

While the specification concludes with claims defining the features of the invention that are regarded as novel, it is believed that the invention will be better understood from a consideration of the following description in conjunction with the figures, in which like reference numerals are carried forward.

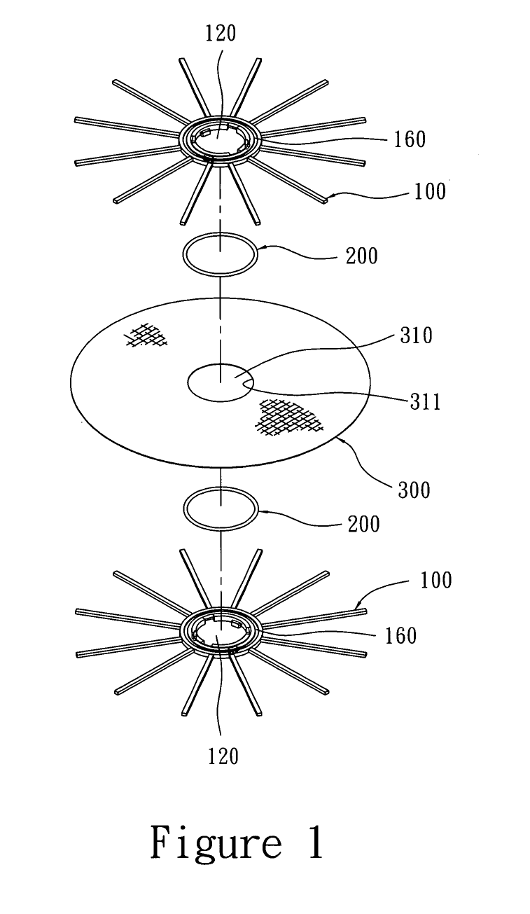

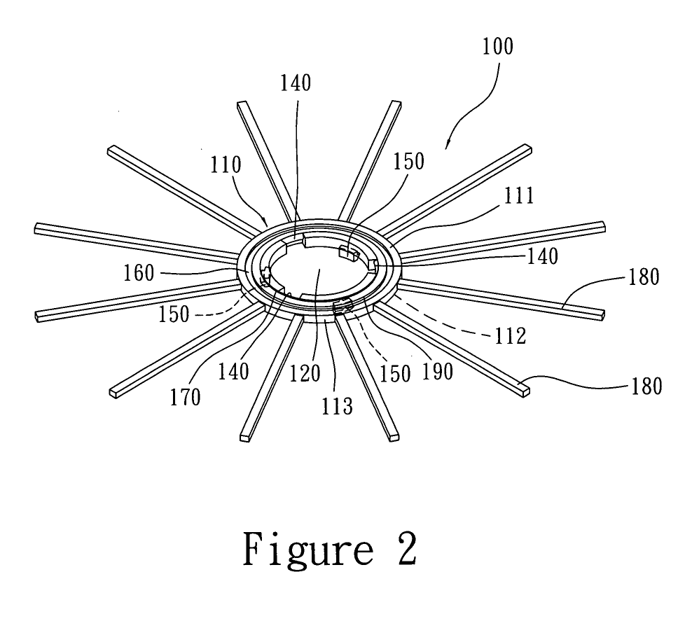

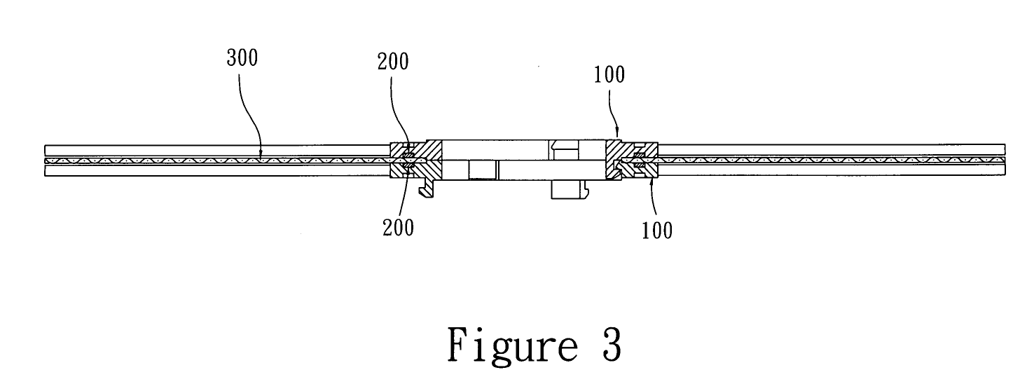

Refer to FIG. 1, FIG. 2 and FIG. 3. FIG. 1 is a perspective exploded view of the embedded water conducting disc module. FIG. 2 is a perspective view of the embedded water conducting disc module. FIG. 3 is a sectional view of the module with two discs and one filtering membrane.

The embedded water conducting disc module includes multiple water conducting discs 100, multiple sealing rings 200 and multiple filtering membranes 300. In the drawing, only two water conducting discs 100, two sealing rings 200 and one filtering membrane 300 are shown to illustrate the embedded water conducting disc module.

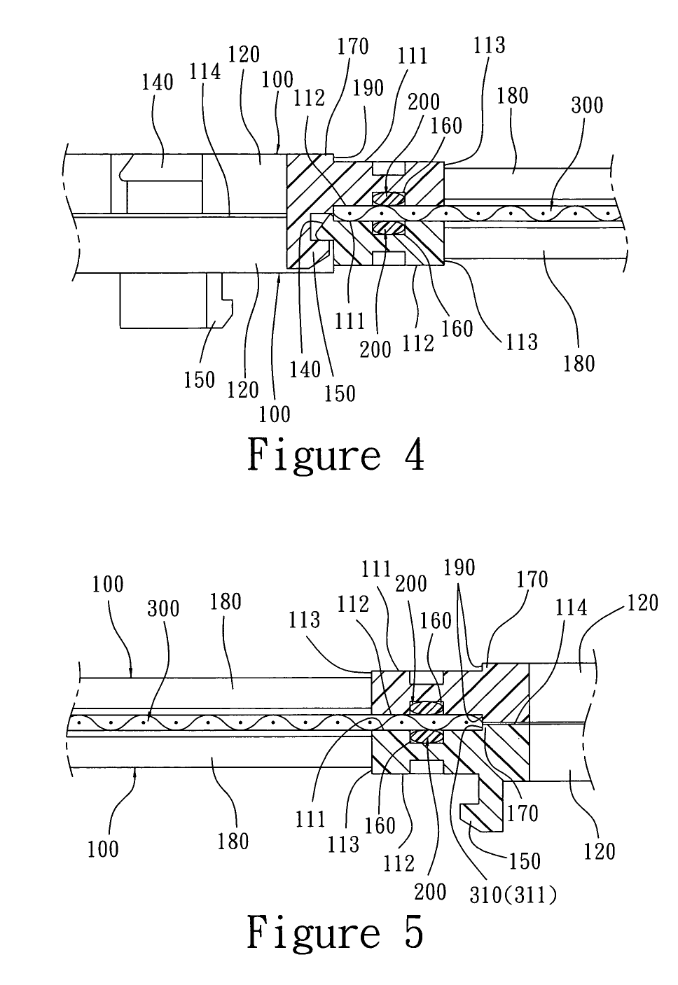

Refer to FIG. 2, FIG. 4 and FIG. 5. FIG. 4 is an enlarged view in partial in accordance with FIG. 3. FIG. 5 is an enlarged view in partial in accordance with FIG. 3.

The water conducting discs 100 are stacked sequentially on one another, and one filtering membrane 300 is clipped between adjacent water conducting discs 100. Each of the water conducting discs 100 includes a disc body 110, an opening 120, at least one locking portion 140, at least one embedded portion 150 and multiple frames 180. The disc body 110 has a first surface 111 and a second surface 112 opposite to each other. The opening 120 is defined through the disc body 110 along a central axis (shown in FIG. 1). The locking portions 140 are alternately defined inside the opening 120. The embedded portions 150 are alternately protruded from the second surface 112 of the disc body 110 and correspond respectively to the locking portions 140 of the adjacent water conducting disc 100. The frames 180 are alternately protruded outward from a periphery 113 of the disc body 110 in the form of radial arrangement.

The disc body 1 10 further includes two protruding edges 170 respectively protruded outward form the first surface 111 and the second surface 112. Thus, two altitudes 190 are respectively formed on the first surface 111 and the second surface 112. The filtering membrane 300 is clipped in a space provided by adjacent altitudes 190 of adjacent water conducting discs 100.

The disc body 110 further includes two grooves 160 respectively formed on the first surface 111 and the second surface 112 of the disc body 110. The sealing rings 200 are made of rubber and are respectively mounted in each of the grooves 160 of the water conducting discs 100.

Refer to FIG. 1, FIG. 4 and FIG. 5. Each of the filtering membranes 300 has a hole 310 defined along the axis. An inner periphery 311 of the filtering membrane 300 is less than the groove 160 but bigger than the opening 120 of the water conducting disc 100.

Refer to FIG. 2, FIG. 4 and FIG. 5. The embedded portion 150 of the water conducting disc 100 is a hook like and the locking portion 140 is a fastener interlocked with the hook. While fabricating the embedded water conducting disc module, stacking the filtering membrane 300 upon the first surface 111 of the water conducting disc 100, locating the inner periphery 311 of the filtering membrane 300 in the altitude 190 of the water conducting disc, and stacking another water conducting disc 100 to make the filtering membrane 300 being clipped between the adjacent water conducting discs 100. By pressing the adjacent water conducting discs 100 correspondingly, the embedded portion 150 of the water conducting discs 100 is interlocked with the locking portion 140 of an adjacent water conducting disc 100. The sealing rings 200 mounted in the grooves 160 are also attached to the filtering membrane 300 to prevent water leakage.

Refer to FIG. 4. When the filtering membrane 300 must be replaced, the interlocked embedded portion 150 and the locking portion 140 are separated by inserting a tool into the stacked water conducting discs 100 to loosen the adjacent water conducting discs 100. In this way, the procedures of the fabrication and disassembly for cleaning or replacement are easy and also convenient.

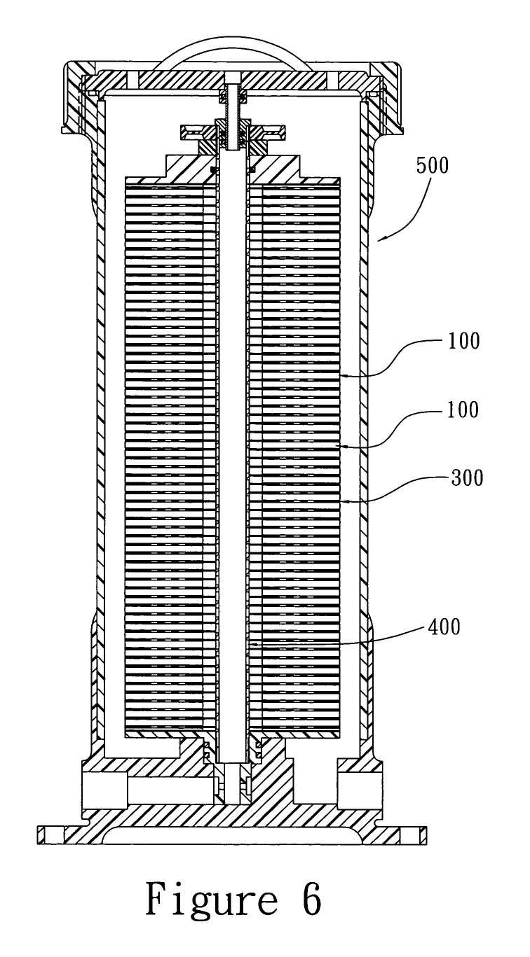

Refer to FIG. 5 and FIG. 6. A void 114 is formed between adjacent water conducting discs such that the raw water filtered by the filtering membrane 300 is guided to the opening 120 to output through the void 114. Therefore, the embedded water conducting disc module holds a conduit 400 to apply to the filtering device 500, such as family or large scaled water processing device.

The conventional water conducting disc module with separated rotatable vane and water conducting disc has high manufacturing cost because of component numbers. The frames 180 and the disc body 110 of the embedded water conducting disc module of the present invention are constituted as a whole such that the manufacturing cost is reduced.

According to the composition and the embodiments above, there are many advantages of the embedded water conducting disc module of the present invention, such as:

1. Compared to the conventional water conducting disc module, the embedded water conducting disc module of the present invention presses the adjacent water conducting discs correspondingly to interlock with each other and fastens the filtering membrane 300 firmly. Therefore, the fabricating operation is easier and more convenient.

2. The embedded water conducting disc module separates the interlocked water conducting discs 100 by inserting a tool into the adjacent water conducting discs before replacing the filtering membrane 300. This method accelerates the disassembly of the embedded water conducting disc module of the present invention.

3. Compared to the conventional water conducting disc module with separated rotatable vane and water conducting disc, the frames 180 and the disc body 110 of the embedded water conducting disc module of the present invention are constituted as a whole such that the manufacturing cost is reduced.

4. The embedded water conducting disc module of the present invention is more suitably applied to the small-scale water filtering device used in the family because of its simple and convenient fabrication.

Although the present invention has been described in considerable detail with reference to certain preferred embodiments thereof, other embodiments are possible. Therefore, their spirit and scope of the appended claims should no be limited to the description of the preferred embodiments container herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. An embedded water conducting disc module holding a conduit and clipping a plurality of filtering membranes, comprising:
multiple water conducting discs stacked with one by another, wherein one of the filtering membranes is clipped between each pair of adjacent water conducting discs, each of the water conducting discs comprising:
a disc body including a first surface, a second surface opposite to the first surface and a central axis;
an opening defined through the disc body along the central axis to hold the conduit;
at least one locking portion defined inside the opening;
an embedded portion corresponding to each one of the at least one locking portion protruded from the second surface of the disc body and engaging the corresponding locking portion; and
multiple frames protruded outward from a periphery of the disc body.

2. The embedded water conducting disc module of claim 1, wherein the disc body of each of the water conducting discs further comprises two grooves respectively formed on the first surface and the second surface.

3. The embedded water conducting disc module of claim 2, further comprising sealing rings respectively mounted in the grooves.

4. The embedded water conducting disc module of claim 1, wherein the at least one locking portion comprises three locking portions arranged complementarily with the corresponding embedded portion.

5. The embedded water conducting disc module of claim 4, wherein each of the locking portions is a hook, and the corresponding embedded portion engages the hook.

6. The embedded water conducting disc module of claim 1, wherein the frames protruded outward from the periphery of the disc body in a radial arrangement.

7. The embedded water conducting disc module of claim 2, wherein each of the filtering membranes further comprises a hole defined along the axis and an inner periphery, wherein the inner periphery of the filtering membrane is less than the groove but bigger than the opening of the disc body.

8. The embedded water conducting disc module of claim 1, wherein each of the water conducting discs further comprises two protruding edges respectively formed on the first surface and the second surface to form two altitudes.

9. The embedded water conducting disc module of claim 8, wherein each filtering membrane is clipped in a space provided by corresponding altitudes of adjacent water conducting discs.
